(19) United States
(12) Patent Application Publication
(10) Pub. No.: US 2009/0183543 A1
(43) Pub. Date: Jul. 23, 2009

(54) Thermal Process For Separating Heavy Metals From Ash In Agglomerated Form

(75) Inventor: Mikhail Boutoussov, Wien (AT)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ASH DEC UMWELT AG, Wien (AT)

(21) Appl. No.: 12/298,725

(22) PCT Filed: May 3, 2007
(86) PCT No.: PCT/AT2007/000210

§ 371 Date: Oct. 27, 2008

(30) Foreign Application Priority Data
May 3, 2006 (AT) A 759/2006

(51) Int. Cl. C05B 17/00

(52) U.S. Cl. 71/32

(57) ABSTRACT

A process for separating from each other heavy metals and an ash agglomerate in the form of individual granules or pellets having substrate properties. Environmentally acceptable metal chlorides and, if appropriate, fillers are mixed with the ash in a first step and the resulting mixture is subjected to agglomeration and/or compaction or conversion into particles. The agglomerate obtained in this way is heated to a temperature above the boiling point of the heavy metal chlorides. The resulting gaseous heavy metal chlorides are separated from the agglomerate. The remaining porous ash agglomerate is depleted in heavy metals and can be used as fertilizer in an original, milled or regranulated particle form.

### CROSS-REFERENCES TO RELATED APPLICATIONS

This application claims priority from Austrian patent application No. A 759/2006 filed May 3, 2006 and PCT Application No. PCT/AT2007/000210 filed May 3, 2007, which are incorporated herein by reference.

### BACKGROUND OF THE INVENTION

The invention relates to a method for separating heavy metals from ash according to claim 1 as well as an ash agglomerate according to claim 12.

The invention concerns the treatment of ash, in particular ash containing phosphorus, from a wide variety of sources. Ash containing phosphorus is an especially important source for producing phosphorus fertilizers for plants or grains.

However, legal restrictions currently in force prohibit the use of original, untreated ash as a fertilizer because such ash usually has an unacceptably high heavy metal content such as, for example, lead, copper, cadmium, chromium and/or zinc. For each of these heavy metals, there is an established maximum amount that may not be exceeded.

Table 1 below shows the compositions of different types of ash from a variety of sources and their heavy metal content as well as the maximum content of heavy metals for fertilizers in Austria. Table 1 illustrates that ash may be used as a fertilizer only after the heavy metal content has been reduced.

TABLE 1

| Source | P₂O₅, % | Fe₂O₃, % | Zn, mg/kg | Pb, mg/kg | Cu, mg/kg | Cd, mg/kg | Cr, mg/kg |
|---|---|---|---|---|---|---|---|
| WSO 1-2 | 20.8 | 23.2 | 2575 | 284 | 635 | 5.1 | 104 |
| Vienna | | | | | | | |
| WOS 3 | 20.1 | 18.6 | 1978 | 220 | 543 | 3.4 | 92 |
| Vienna | | | | | | | |
| Vodokanal | | | 2200 | 400 | 730 | 2.7 | 400 |
| S. Pb | | | | | | | |
| Berlin | 15.5 | 22.6 | 2680 | 190 | 1560 | 3.4 | 129 |
| Germany | | | | | | | |
| Wilhelmsh. | 18.1 | 19.6 | 2030 | 156 | 552 | 2.7 | 150 |
| Germany | | | | | | | |
| Noord Brab. | 12.6 | 11 | 2240 | 340 | 970 | 4.1 | 205 |
| Holland | | | | | | | |
| Max. contents | | | 1666¹⁾ | 100 | 388¹⁾ | 11 | 333¹⁾ |
| for Austria | | | | | | | |

¹⁾Max. contents pursuant to shipping regulations

Various methods are known from the state of the art for reducing the heavy metal content of ash and/or separating heavy metals from ash or recovering the valuable phosphorus from ash.

For example, U.S. Pat. No. 4,351,809, U.S. Pat. No. 3,235,330, U.S. Pat. No. 3,241,917 and JP 11319762 or JP 2001198546 describe thermal methods for extracting phosphorus from ash in which ash containing phosphorus is heated in a reducing atmosphere up to 1200° C. in the presence of a material containing carbon. The phosphorus is evaporated during the process and is subsequently condensed in pure form or oxidized. However, these methods are energy-intensive, expensive and involve a large number of process steps.

In addition, methods are known from DE 10206347, U.S. Pat. No. 5,078,786, U.S. Pat. No. 6,770,249 and DE 10206347 in which phosphorus or heavy metals are dissolved and/or leached out of ash in a hydrometallurgical process. However, such hydrometallurgical processes have the disadvantage that they are complicated and expensive. Furthermore, certain toxins, in particular those of an organic nature, may remain behind when employing these methods.

In another method for removing heavy metals, the ash is subjected to a thermal treatment in the presence of a chlorination agent. The ash is heated to a temperature of more than 900° C. in a chlorine gas atmosphere. A disadvantage of this method is that the resulting gaseous metal chlorides must be removed from the reaction area, while the chlorine gas must remain in the reaction area. Such a method functions only on a laboratory scale; it is difficult and very expensive to scale it up to a continuously operating industrial process.

Another possible method is described in DE 10243840, where ash is mixed with metal chlorides, in particular alkali chlorides or alkaline earth chlorides, and the mixture is then heated to 1000 to 1100° C. This supplies a chlorination agent in direct proximity to the ash particles, where it can react locally. The resulting gaseous heavy metal chlorides are removed. This large amount of fine dust is removed together with the heavy metal chlorides. A disadvantage of this method is that all metal parts of the thermal reactor are exposed to the aggressive chlorine gas at high temperatures, which causes severe corrosion. Furthermore, chlorine gas is less effective for removing heavy metals than is HCl vapor at the same temperatures. In addition, this method does not function when using a viscous paste of ash, salts and water. As a result, this method is economically inefficient.

### BRIEF SUMMARY OF THE INVENTION

It is an object of the present invention to provide an alternative method for separating heavy metal chlorides from ash without the disadvantages of the state of the art as summarized above. The method of the present invention has a good extraction efficiency for heavy metals, damages and/or corrodes the reactor less, and is easy, safe and inexpensive to carry out.

This object is achieved by the inventive method defined by claim 1.

The method of claim 1 has the advantage that it yields an agglomerate of ash and chlorides, which serves as a compact starting material that is easy to handle and does not generate dust. When granules are formed, a surprisingly high extraction rate of the heavy metals to be removed is attained, in particular of the heavy metals that are most harmful to the environment, such as Cu, Zn, Pb, Cd, Cr, etc. This allows a dramatic reduction in the heavy metal burden of the ash and makes it possible to reach a range far below the established content limits. The metals that are harmless for the environment, such as compounds with Si, Al, Mg, Ca, Mn, are not reacted by this method. Any organic compounds that might still remain after incineration and/or pyrolysis are completely destroyed in the course of this method, which yields very pure, uncontaminated granules.

An advantageous composition of the starting mixture in which there is efficient extraction is defined by claim 2.

In accordance with claim 3, other fillers may also be granulated together with the ash and the salts. This leads to cost savings in the process. At the same time, the final composition of the ash free of heavy metals that is thereby obtained is readily controllable and can be determined in advance.

Another advantageous alternative for adding the salts to the ash is defined by claim 4, which greatly facilitates the granulation process. Furthermore, the dust burden during granulation is reduced.

Granulation is advantageously performed according to claim 5 to effectively control the extraction efficiency.

An especially efficient heating profile is defined by claims 6 and 7. Heavy metals extraction is achieved at a very high efficiency while the reactor is protected.

The features of claim 8 define advantageous maximum temperatures for magnesium chloride and calcium chloride at which the process is most effective.

Advantageous methods of heating are defined by the features of claim 9.

The choice of grain sizes for the starting materials affects the formation of granules and the efficiency of heavy metal reduction. The grain sizes are advantageously as defined by claim 10.

Claim 11 defines a method for producing fertilizers that employs the above-described method for obtaining granules. In this way the composition of the granules can easily be varied and controlled.

The method of the present invention yields an ash agglomerate of an especially advantageous composition and structure. This inventive ash agglomerate can be used directly as a substrate and/or as a fertilizer because it has excellent properties with regard to phosphorus availability.

The ash agglomerate is characterized by the features of claim 12. A sintered matrix produces the advantageous substrate properties in contrast, for example, to ash granules that have only been cold compacted and/or granulated.

The ash agglomerate advantageously has a structure in accordance with claim 13.

Advantageous sizes of the ash agglomerate are set forth in claim 14.

The porosities set forth in claim 15 ensure an advantageous substrate effect.

The ash agglomerate has a phosphorus pentoxide content according to claim 16, which is important for fertilizers.

For substrate properties as a fertilizer, it is advantageous to use the features set forth in claim 17.

Phosphorus losses due to leaching are prevented by the features of claim 18.

To meet miscibility criteria, it is advantageous to make use of the features of claim 19.

Claim 20 generally defines an advantageous fertilizer produced on the basis of such ash agglomerates.

### DETAILED DESCRIPTION OF THE INVENTION

The ash that is to be treated to free it of heavy metals is obtained by incinerating sewage sludge and/or biowaste, e.g. wood waste, recycled paper, etc., and in particular such waste containing phosphate. This includes ash with a phosphorus content in the range of approximately 5 to 30%. Organic pollutants including endocrine substances and the like are largely destroyed by the incineration process. The most important chemical constituents of such ashes are SiO₂, CaO, Al₂O₃, Fe₂O₃ and P₂O₅. However, heavy metals, in particular Pb, Cd, Cr, Cu, Ni, Co, Zn, Hg, etc., are also present.

The ash particles are subdivided essentially into two groups, namely the aerosol particulates or flue ash on the one hand and the coarse particles on the other hand.

The aerosol particulates have a diameter of approximately 0.5 μm while the coarse particles have a diameter of between about 30 μm to 50 μm. As a result, the ash has a very large specific surface area of approximately 5 m²/g to 6 m²/g.

The shape of aerosol particulates tends to be regular, e.g. rectangular or rod-shaped, while the coarse particles usually have an irregular shape.

The chemical composition of the aerosol particulates comprises primarily heavy metal salts and heavy metal oxides. The coarse particles tend to comprise complex compounds such as aluminosilicates and the like.

The concentration of heavy metals also differs significantly between the aerosol particulates and the coarse particles. For example, aerosol particulates have a zinc concentration of up to 40,000 mg/kg and a cadmium concentration of approximately 100 mg/kg, while coarse particles have a zinc concentration of approximately 550 mg/kg and a cadmium concentration of approximately 30 mg/kg.

The formation of such ash particles also varies. Aerosol particles are formed by volatile elements containing heavy metals, which evaporate during thermal decomposition of the waste. The coarse ash particles are formed by partial melting of dust from the incinerated waste.

The method of the present invention for reducing the heavy metal content in ash adds in a first step environmentally acceptable metal chlorides, in particular alkali metal chlorides and/or alkaline earth metal chlorides, with or without water of crystallization, to ash containing heavy metals. Alkali metal chlorides and/or alkaline earth metal chlorides include in particular calcium chloride, potassium chloride or magnesium chloride, although other environmentally acceptable metal chlorides are also possible.

Fillers may also be added. Through appropriate choice of the starting materials and/or fillers, the composition of the end product can be controlled, which enables designing fertilizers for specific applications.

The alkali metal chlorides and/or alkaline earth metal chlorides may be added in the form of dry powder or as an aqueous solution of the chlorides. Such an aqueous solution contains about 5 to 40% by weight of alkali metal chloride and/or alkaline earth metal chloride.

The mixing ratios of ash and alkali metal chloride and/or alkaline earth metal chloride may be varied over certain ranges. An advantageous mixture has 60 to 95% by weight ash and 5 to 40% by weight metal chlorides, based on the total weight of the mixture.

When fillers are added, they are added to the mixture of ash and metal chlorides in an amount of approximately 5 to 40% by weight, based on the total weight of the mixture. Such a composition of the ready-to-granulate mixture then has 55 to 90% by weight ash, 5 to 40% by weight metal chlorides, and 1 to 50% by weight, preferably 3 to 20% by weight, fillers. Suitable fillers include finely ground coal, alumina, ground sewage sludge, fine wood waste or finely ground paper waste. In particular, fine-grained inorganic material that does not release toxic gases when heated above 900° C. may also be used. For example, lime may be used for this purpose. The fillers may also be added in liquid form, e.g. in the form of 30% H₃PO₄.

It is advantageous if the starting materials for granulation are relatively fine grained. The grain sizes of the ash and the metal chlorides should be less than 500 μm and the grain sizes of the fillers should be less than 1000 μm.

In addition, before granulation the mixture should be as homogeneous as possible.

In a next step, agglomeration and/or compacting and/or pelletization of the powdered mixture takes place. Depending on the process management, irregular granules may be shaped as asymmetrical aggregates and/or regularly shaped pellets. The granulation/pelletization of the mixture is done according to known methods. Granulation is mentioned as an example below.

The granulation should yield granules with a diameter in the range of about 3 to 30 mm.

The resulting granules are then heated. This forms heavy metals chlorides in the granules, which become volatile at a certain temperature and can be separated. It is therefore important for the granules to be heated to a temperature above the boiling point of the heavy metal chlorides that are being formed. An effective separation of the heavy metals from the ash is thereby achieved.

To increase the extraction efficiency, heating may take place in two stages. The temperature is below the boiling point of the resulting heavy metal chlorides for a certain period of time, in particular for at least 30 minutes, during a first heating and/or drying step and is preferably kept constant. In this way the granules are dried to minimize the energy consumption in the following thermal process.

Next, in a second, heating step, the temperature is raised to a level above the boiling point of the resulting heavy metal chlorides. The temperature is then kept constant, preferably for a maximum of 60 minutes.

During the first heating and/or drying step, the temperature should be below 300° C.; the temperature during the second heating step should be between 900 and 1100° C. Below 900° C., the temperature is too low to ensure an efficient removal of the heavy metal burden as gaseous chlorides; at temperatures above 1100° C., the granules begin to sinter and the yield suffers. Since the heavy metal chlorides evaporate mainly in the range between 900° C. and 1000° C., it is advantageous to heat the granules to a temperature of >1000° C. to achieve an optimal yield. The closer the temperature is to 1100° C., the more advantageous and effective is the heavy metal removal.

When magnesium chloride is used, the temperature during the first heating step should be below 110° C.; when calcium chloride is used, the temperature during the first heating step should be below 260° C.

The heating may be performed directly or indirectly in a single reactor, in particular in a tubular rotary oven or in two successive reactors, in particular a dryer and a tubular rotary oven.

Thereafter the gaseous heavy metal chlorides are removed from the reactor, condensed and separated in a dust filter or a wet scrubber.

The following example describes an advantageous method of carrying out the process:

Sewage sludge ash at room temperature is fed dry into a mixer. To this is added an alkaline earth chloride mixture and possibly some fillers to reduce the energy demand in the downstream thermal unit. The weight ratio of ash to chloride is approximately 85:15. When fillers are added, this ratio is adjusted proportionally. The maximum amount of filler is about 40% by weight. In the mixer, fresh water is added to adjust the water content to approximately 25% by weight. The mixing time is at most 10 minutes.

The mixture is placed on a granulating disk to produce pellets of a size between about 5 to 20 mm. The granulation lasts for about 5-15 minutes. If needed, more water may be added to optimize the granulation process.

Water is removed from the pellets in a dryer at a maximum temperature of 150° C. The drying process requires approximately 10 minutes and can be carried out in a drum dryer or a belt dryer.

The dried pellets are heated in a heating device to just below their sintering temperature, in this case to approximately 900-1000° C. The dwell time at this temperature is at least 10 minutes; it is important to be sure that the temperature is kept constant in the range of 900° C. to 1000° C.

The resulting flue gases are subjected to wet flue gas cleaning to conform them to the established guidelines when they reach the flue discharge. The residue left over from flue gas cleaning can be sorted if desired and is dumped above ground.

The pellets freed of heavy metals are discharged into a cooler where they heat air that is used in the thermal process again. The pellets cooled to ambient temperature are ground, mixed with the remaining nutrients and granulated to yield a multinutrient fertilizer having the same chemical and physical properties as traditional fertilizers.

Tables 2a and 2b below show a few examples of the removal of heavy metals when MgCl₂ and KCl are used as chlorine donors.

TABLE 2a

| | | | | Cd | | Cu | | Pb | | Zn | |
|---|---|---|---|---|---|---|---|---|---|---|---|
| Ash | MgCl₂ | Temp. | Time | in (mg/kg | out (mg/kg | in (mg/kg | out (mg/kg | in (mg/kg | out (mg/kg | in (mg/kg | out (mg/kg |
| (%) | (%) | (° C.) | (min) | dry solids) | dry solids) | dry solids) | dry solids) | dry solids) | dry solids) | dry solids) | dry solids) |
| 95 | 5 | 900 | 30 | 3 | 1 | 502 | 401 | 233 | 58 | 1817 | 1096 |
| 90 | 10 | 1000 | 30 | 3 | 1 | 483 | 325 | 232 | 27 | 1752 | 751 |
| 85 | 15 | 1100 | 30 | 3 | 0 | 405 | 205 | 194 | 14 | 1506 | 440 |

TABLE 2b

| | | | | Cd | | Cu | | Pb | | Zn | |
|---|---|---|---|---|---|---|---|---|---|---|---|
| Ash | KCl | Temp. | Time | in (mg/kg | out (mg/kg | in (mg/kg | out (mg/kg | in (mg/kg | out (mg/kg | in (mg/kg | out (mg/kg |
| (%) | (%) | (° C.) | (min) | dry solids) | dry solids) | dry solids) | dry solids) | dry solids) | dry solids) | dry solids) | dry solids) |
| 95 | 5 | 900 | 30 | 3 | 1 | 483 | 134 | 212 | 16 | 1779 | 1422 |
| 90 | 10 | 1000 | 30 | 3 | 1 | 413 | 104 | 181 | 14 | 1536 | 1277 |
| 85 | 15 | 1100 | 30 | 3 | 0 | 390 | 46 | 187 | 9 | 1446 | 1117 |

The granules that have been effectively freed of heavy metals are then used directly as a fertilizer or they are further processed into the desired fertilizer.

Table 3 shows the release rates for phosphorus from the resulting granules having a reduced heavy metal content.

TABLE 3

| Total amount | Amount of P₂O₅ | Amount of P₂O₅ | Amount of P₂O₅ |
|---|---|---|---|
| of P₂O₅, % | diluted in water, % | diluted in neutral CA, % | diluted in citric acid, % |
| 11.20 | 3.69 | 6.74 | 11.18 |

The method of the present invention yields an ash agglomerate and/or ash granules that have extremely advantageous properties for fertilization. The ash granules obtained by this method have a special matrix of ash, comprising in particular silicon, aluminum, magnesium, phosphorus, calcium and/or iron compounds. The matrix of these ash granules has a sintered structure, a structure that cannot be obtained with traditional methods in which ash and aggregates are mixed and/or granulated cold.

The matrix is made up of mostly amorphous regions, but partially crystalline regions may also be present in relatively small percentage amounts. The matrix has an aluminosilicate structure.

The granular particles have a particle size of approximately 2 to 5 mm or more. The granular particles also have a porosity between 20 and 40% by volume based on the volume of the individual granule particle.

The phosphorus pentoxide content of each individual granular particle is more than 10% by weight, based on the weight of each granular particle.

The resulting phosphorus pentoxide is 80 to 100%, in particular 90 to 100% soluble in citric acid, and is in particular soluble in 2% citric acid. Furthermore, the phosphorus pentoxide obtained is almost insoluble, in particular more than 70% insoluble, to prevent losses of phosphorus due to leaching. The aforementioned percentage amounts are based on the total amount of P₂O₅ present.

As already pointed out, the heavy metal contents are reduced and are significantly below the required limits. The zinc content varies below 0.025% by weight and the cadmium content varies below 0.00015% by weight. The lead content is in a range of less than 0.001% by weight and the copper content is less than 0.01% by weight, with the percentages by weight/per mil being each based on the weight of a pellet and/or a granular particle.

To obtain a fertilizer that fulfills the desired requirements and has the relevant components from the resulting ash agglomerate and/or the granules with a reduced heavy metal content, the granules may either be pulverized or ground, and then a ground additive containing the desired nutrients can be added. Alternatively, fine or coarse aggregates may also be added to the granules and the mixture, which is then pulverized or ground to the proper grain size. The fertilizer mixture, now complete, may also be granulated again.

What is claimed is:

1. A method for separating heavy metals, e.g. Pb, Cu, Cd, Zn, etc., from ash, in particular from sewage sludge ash, comprising in a first step adding environmentally benign metal chloride, in particular alkali metal chlorides and/or alkaline earth metal chlorides, preferably CaCl₂, KCl or MgCl₂, and optionally fillers to form a mixture, subjecting the mixture to at least one of agglomerating, compacting and pelletizing, in particular granulating them and/or processing them into granules, thereafter heating a resulting agglomerate to a temperature above the boiling point of the heavy metal chlorides that are being formed, and separating gaseous heavy metal chlorides from the agglomerate.

2. A method according to claim 1 wherein subjecting comprises using a powdered mixture, in particular a homogeneous mixture, of 60 to 95% by weight of ash and 5 to 40% by weight of alkali metal chlorides and/or alkaline earth metal chlorides, based on the total weight of the mixture.

3. A method according to claim 1 wherein subjecting comprises using a powdered mixture, in particular a homogeneous mixture, of 55 to 90% by weight of ash and 5 to 40% by weight and alkali metal chlorides and/or alkaline earth metal chlorides and 1 to 40% by weight and preferably 3 to 20% by weight of fine grain fillers, in particular fillers adapted to increase porosity, e.g. finely ground coal, pyrolysis coke, sewage sludge, wood waste, paper waste, alumina, etc., and preferably fine-grained inorganic material that does not release toxic gases when heated to above 900° C., e.g. lime.

4. A method according to claim 1 wherein adding the alkali metal chloride and/or alkali earth metal chlorides and optionally the fillers comprises adding an aqueous solution including 5 to 40% by weight of alkali metal chlorides and/or alkaline earth metal chlorides to the ash.

5. A method according to claim 1 wherein subjecting the mixture includes limiting a diameter of resulting granules/pellets to 3 to 30 mm.

6. A method according to claim 1 wherein heating the agglomerate is performed in two stages comprising maintaining the temperature of the agglomerate in a first heating step to below a sublimation point of resulting heavy metal chlorides, and in particular keeping the temperature during the first heating step constant for a certain period of time, preferably for at least 30 minutes, thereafter heating the agglomerate in a second heating step to a temperature above a boiling point of the resulting heavy metal chlorides, and preferably keeping the temperature above the boiling point for up to 60 minutes preferably constant.

7. A method according to claim 1 wherein heating of the agglomerate is performed in two steps comprising maintaining the temperature of the agglomerate in a first heating step below 300° C., in particular keeping the temperature constant for a certain period of time, preferably for at least 30 minutes, thereafter heating the agglomerate in a second heating step to a temperature of 900° C. to 1100° C., and preferably keeping the temperature of 900° C. to 1100° C. up to 60 minutes, preferably constant.

8. A method according to claim 6 wherein the temperature in the first heating step is kept below 110° C. when using MgCl₂ and is kept below 260° C. when using CaCl₂.

9. A method according to claim 1 wherein heating is performed directly or indirectly in one of a single reactor and two successive reactors.

10. A method according to claim 1, including providing the ash and the alkali metal chlorides and/or alkaline earth metal chlorides in a grain size of <500 μm and providing the fillers in a grain size of <1000 μm.

11. A method for producing fertilizers from a heavy metal reduced agglomerate, in particular granules, obtained in accordance with claim 1, further comprising pulverizing and/or grinding the resulting agglomerate and then adding thereto at least one ground additive or adding to the resulting agglomerate at least one aggregate to form a mixture therewith which is pulverized and/or ground to the desired grain size, and optionally agglomerating the mixture.

12. An ash agglomerate in the form of individual granule particles and/or pellets having substrate properties that make them suitable for further processing into fertilizers and produced in accordance with the method of claim 1.

13. An ash agglomerate according to claim 12 wherein the matrix comprises a homogeneously structured aluminosilicate structure.

14. An ash agglomerate according to claim 12 wherein the granule particles and/or pellets have particle sizes of more than 2 mm, and preferably more than 5 mm.

15. An ash agglomerate according to claim 12 wherein the granule particles and/or pellets have a porosity between 20 and 40% by volume based on the volume of each pellet and/or granule particle.

16. An ash agglomerate according to claim 12 wherein the granule particles and/or pellets have a P₂O₅ content of more than 10% by weight based on the weight of each pellet and/or granule particle.

17. An ash agglomerate according to claim 12 wherein the resulting P₂O₅ is 80 to 100% and preferably is 95 to 100% soluble in citric acid, and preferably in 2% citric acid.

18. An ash agglomerate according to claim 12 wherein the resulting P₂O₅ is largely insoluble, in particular is more than 70% insoluble, and preferably is more than 85% insoluble in water.

19. An ash agglomerate according to claim 12 in the form of individual particles and/or pellets having substrate properties that make them suitable for further processing into fertilizers comprising a sintered matrix of ash of Si, Al, Mg, P, Ca and/or Fe compounds, and wherein each granule particle or pellet includes a heavy metal content of
Zn<0.025% by weight
Cd<0.00015% by weight
Pb<0.001% by weight and
Cu<0.01% by weight,
based on the weight of each pellet and/or granule particle.

20. A fertilizer including an ash agglomerate according to claim 12 which is preferably comprised of original particles, ground particles and/or optionally regranulated particles.

21. A method of using an ash agglomerate according to claim 12 as a fertilizer.
